(19) United States
(12) Patent Application Publication
(10) Pub. No.: US 2012/0061065 A1
(43) Pub. Date: Mar. 15, 2012

(54) HEAT-ABSORBING STRUCTURAL MATERIAL

(76) Inventor: Ross M. LaCombe, Sahuarita, AZ (US)

(21) Appl. No.: 12/882,464

(22) Filed: Sep. 15, 2010

(51) Int. Cl. F28F 7/00; B32B 3/00; E04B 1/76; B32B 15/08

(52) U.S. Cl. 165/185; 428/34.1; 428/35.7; 428/593

(57) ABSTRACT

A heat-absorbing structural material has a sealed outside shell or container, and an internal structure in the interior space enclosed by the container. In addition the structural material has a phase-change material in the interior space, interspersed between elements of the internal structure. The internal structure provides increased strength to the structural material, allowing it to better withstand external forces placed on it. The phase change material may change from a solid to a liquid during operation of the structural material as a heat absorber, such as a heat sink. The internal structure may be made as an integral part of the structural material, formed with at least part of the container by a three-dimensional printing process, or by casting. The phase change material, such as a suitable wax, may improve heat-absorbing performance of the structural material by changing phase during heating.

### GOVERNMENT RIGHTS

This invention was made with United States Government Support under Contract Number HQ0276-08-C-0001 with the Missile Defense Agency. The United States Government has certain rights in this invention.

### BACKGROUND OF THE INVENTION

1. Technical Field of the Invention

The invention is in the field of heat-absorbing materials.

2. Description of the Related Art

Use of heat-producing devices has spawned a need for absorbing the heat produced by such devices. Heat absorption has been accomplished by solid metal pieces, such as metal slabs or blocks, but such objects are heavy and can take up considerable volume.

### SUMMARY OF THE INVENTION

According to an aspect of the invention, a heat-absorbing structural material includes: a sealed container; an inner structure within the container for providing structural support to the container; and a phase-change material within the sealed container and interspersed around the inner structure.

According to another aspect of the invention, a method of absorbing heat includes the steps of: receiving the heat on a face of a sealed container of a heat-absorbing structural material; and transferring the heat from the sealed container to a phase-change material that is in an interior space within the container and defined by the container. The transferring of the heat includes melting at least some of the phase-change material.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various features of the invention.

FIG. 1 is an oblique view of a heat-absorbing structural material in accordance with an embodiment of the present invention.

FIG. 2 is another oblique view of the structural material of FIG. 1.

FIG. 3 is a cross-sectional view of part of the structural material of FIG. 1, showing one arrangement of internal structure material for the structural material.

FIG. 4 is an oblique view showing one possible configuration of the internal structure of the structural material.

FIG. 5 is an oblique view showing another possible configuration of the internal structure of the structural material.

FIG. 6 is an oblique view showing one application of a heat-absorbing structural material, as at least part of a fin or control surface of a missile or other aircraft.

FIG. 7 is an oblique view showing another application of a heat-absorbing structural material, as a heat sink for a heat-producing element, as part of an electrical or electronic device.

### DETAILED DESCRIPTION

A heat-absorbing structural material has a sealed outside shell or container, and an internal structure in the interior space enclosed by the container. In addition the structural material has a phase-change material in the interior space, interspersed between elements or members of the internal structure. The internal structure provides increased strength to the structural material, allowing it to better withstand external forces placed on it. The phase-change material may change from a solid to a liquid during operation of the structural material as a heat absorber, such as functioning as a heat sink. The internal structure may be made as an integral part of the structural material, formed with at least part of the container by a three-dimensional printing process, or by a casting process. The phase-change material, such as a suitable wax, may improve heat-absorbing performance of the structural material by changing phase during heating. This allows the heat-absorbing structural material to absorb more energy, while weighing less, relative to a solid piece of material such as a monolithic metal block or slab.

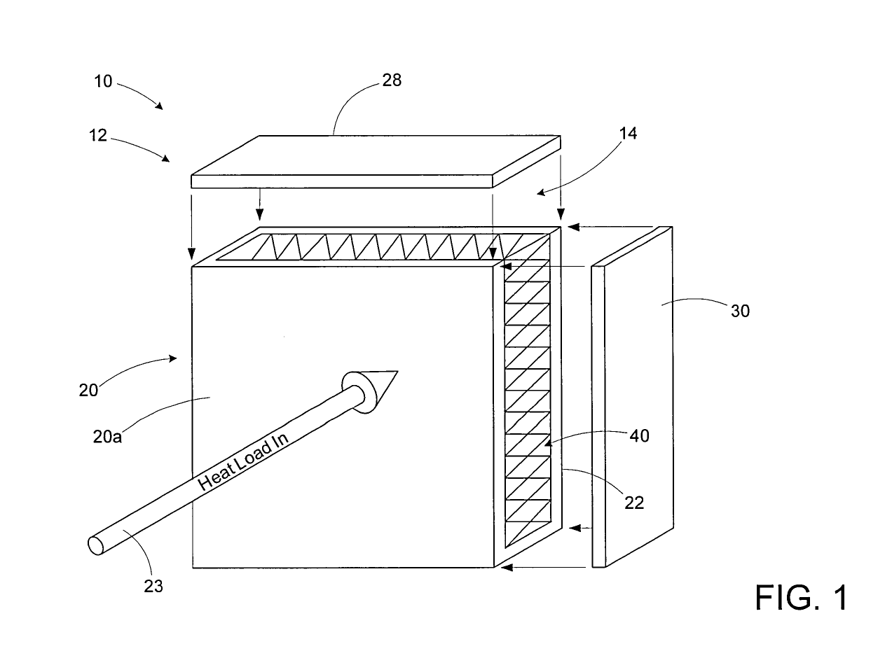

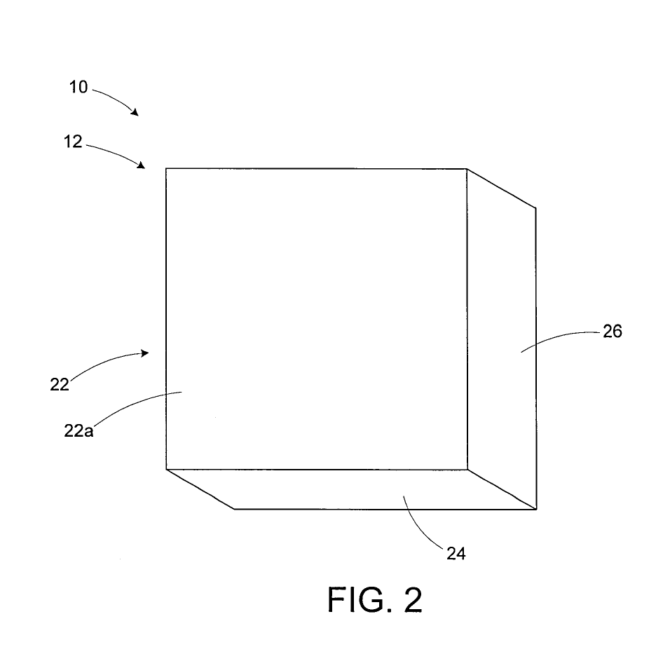

FIGS. 1 and 2 show a heat-absorbing structural material 10. The material 10 includes a sealed outside shell or container 12 that encloses an interior space 14 that is within the container 12 and is defined by the container 12. The container 12 includes a front plate 20 and an aft or back plate 22. The plates 20 and 22 are shown as rectangular and flat, and substantially parallel to one another, but it will be appreciated that the plates 20 and 22 may have other configurations. For instance the plates 20 and 22 may have other shapes, such as being curved, and/or may be other than substantially parallel to one another. The heat to be absorbed 23 may be received on one or both faces 20a and 22a of the plates 20 and 22.

A set of sides 24, 26, 28, and 30 connect together the plates 20 and 22. Some (one or more) of the sides 24-30 may be integrally formed as part of the plates 20 and/or 22, while other (one or more) of the sides 24-30 may be cap(s) that are separate pieces that are sealed to the plates 20 and 22, after introduction of the phase-change material into the enclosed interior space 14. Optionally the sealed container 12 may include a vent, to equalize pressure between the interior space 14 and the environment around the container 12. In the illustrated embodiment the sides 24 and 26 are integrally formed with the plates 20 and 22, while the sides 28 and 30 are separate cap pieces that are joined to the plates 20 and 22. The sides 28 and 30 may be joined to the plates 20 and 22 and sealed by use of any of a variety of suitable methods, such as by being welded, or by being mechanically coupled together, for instance by use of fasteners, such as rivets or threaded fasteners such as bolts, with a suitable gasket used to seal the joint at the connection.

An internal structure 40 is located in the interior space 14. The internal structure 40 is a lattice structure or other configuration of structure that provides structural support for the structural material 10, allowing the structural material 10 to better withstand external forces on it. The internal structure 40 increases component strength, stiffness, and thermal conductivity to phase change material, etc., without appreciably increasing weight of the structural material 10, at least relative to a solid metal structural material.

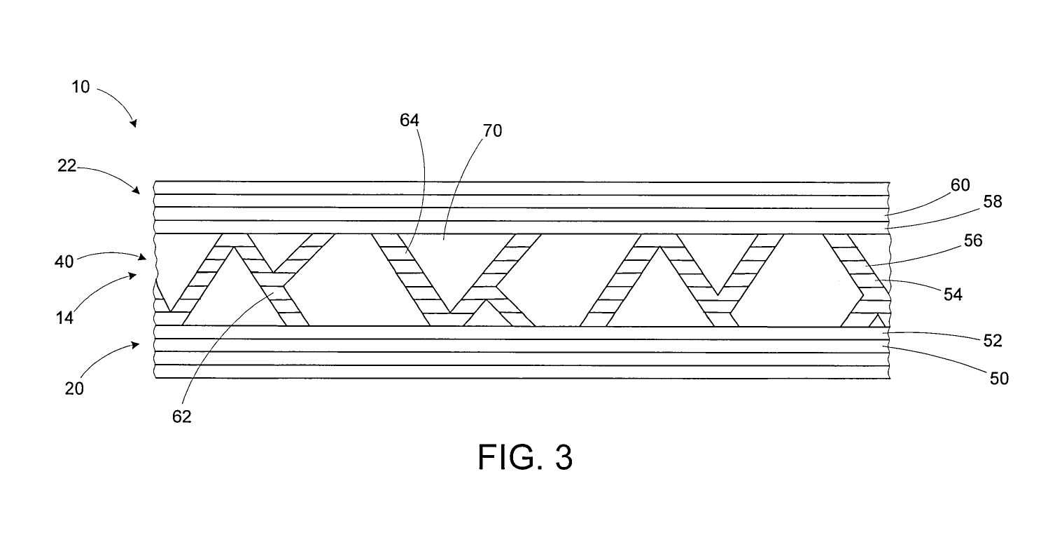

The internal structure 40 may be an integral part of other parts of the structural material 10. Specifically, the internal structure 40 may be integrally formed with one or both of the plates 20 and 22, as well as possibly also one or more of the sides 24-30. With reference to FIG. 3, the internal structure and the plates 20 and 22 may be built up using a three-dimensional printing process. In such a process a series of layers, some of which are the layers 50-60, are printed, one on top of each other, to produce in stages the main structure of the structural material 10. The lower layers, such as the layers 50 and 52, are fully printed layers that constitute the front plate 20. The middle layers, such as the layers 54 and 56, are partially printed layers for forming parts of the members, such as the members 62 and 64, of the internal structure 40. The portions that are printed to form the members of the internal structure 40 may vary from layer to layer to accommodate diagonal members that vary in location with height from the forward plate 20 to the aft plate 22. The upper layers, such as the layers 58 and 60, are fully printed layers that make up parts of the aft plate 20.

The layers of material may each have a thickness of from 0.05-0.5 mm (0.002-0.02 inches). It will be appreciated that other suitable thicknesses may also be used.

The integrally formed sides 24 and 26 may also be formed as part of the printing process that forms the plates 20 and 22, and the internal structure 40. Use of a printing process can form many of the parts of the heat-absorbing structure 10 as a single monolithic continuous object.

The internal structure (and other parts) can be formed from any of a wide variety of suitable materials. One example of a suitable material is a nickel-chromium alloy marketed under the trademark INCONEL 718. Another suitable material is a titanium alloy, for example Grade 5 alloy (Ti-6Al-4V). These two alloys are suitable for use at high temperatures, which makes them suitable for use in heat sinks that are exposed to high temperatures, for example. It will be appreciated that other materials may be suitable for use for other operation temperatures. High thermal conductivity is a desirable characteristic of the materials for the plates 20 and 22, and the internal structure 40. Therefore it will be appreciated that a wide variety of metals, alloys, and metal-containing materials may be suitable for use.

As an alternative to the printing process described above, casting may be used as a possible fabrication method.

Further, it will be appreciated that the internal structure 40 alternatively may be one of more pieces that are separate from the plates 20 and 22. In other words, the internal structure 40 does not necessarily have to be integrally formed with the plates 20 and/or 22. For example the internal structure 40 may be one or more wire or other metal pieces. The plates 20 and 22 may be solid metal or metal alloy pieces to which the internal structure 40 is attached, for example by welding.

A phase-change material (“PCM”) 70 is located in the interior space 14, interspersed within and around the internal structure 40. The phase-change material 70 can change phase from solid to liquid, melting as a result of heat absorption by the structural material 10, with the other parts of the material 10 still remaining solid. Phase-change materials may in general be any sort of material that changes from solid to liquid during heating at the operating temperature expected for the structural material 10. Broadly speaking, PCMs can be arranged into three categories: eutectics, salt hydrates, and organic materials. Eutectics tend to be solutions of salts in water that have a phase change temperature below 0° C. (32° F.). Salt hydrates are specific salts that are able to incorporate water of crystallization during their freezing process and tend to change phase above 0° C. (32° F.). Organic materials used as PCMs tend to be polymers with long chain molecules composed primarily of carbon and hydrogen. They tend to exhibit high orders of crystallinity when freezing and mostly change phase above 0° C. (32 ° F.). Examples of materials used as positive temperature organic PCMs include waxes, oils, fatty acids and polyglycols. For high-temperature applications, such as for use as heat sinks for electronics or other heat-producing devices, organic materials such as waxes are suitable PCMs. Such materials may have a melting temperature in the range of 47-64° C., or more broadly in the range of 40-70° C.

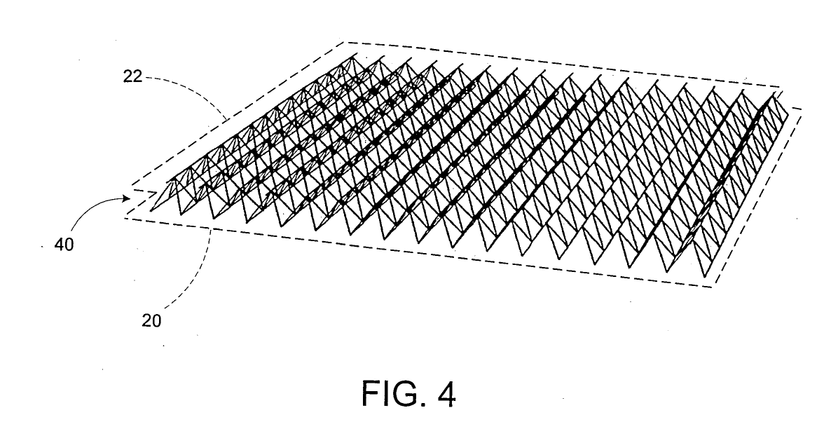

It will be appreciated the internal structure 40 may have any of a variety of configurations. It may be a lattice structure, as shown in FIG. 3. An example of a suitable lattice structure configuration is shown in U.S. Pat. Nos. 5,527,590 and 5,679,467. A similar configuration is shown in FIG. 4, in which the plates 20 and 22 are shown schematically and in phantom lines, for clarity in showing the internal structure 40. The number of elements shown in FIG. 4, and their relative dimensions, is not intended to be limiting. The type of lattice structure shown in FIGS. 3 and 4, with diagonal members forming trusses that support the plates 20 and 22, has the advantage of providing solid support. A truss-like lattice structure having diagonal members support the parts of the structural material 10, the plates 20 and 22, and the sides 24-30, against forces in any of a variety of directions. The illustrated lattice structure is an efficient structure from a mass standpoint, it has high strength, and it will gradually fail under high loads.

Besides providing structural support, the members of the internal structure 40 may aid in transmitting heat into and through the structural material 10. The internal structure 40 may be made as the same conductive material, such as a metal or alloy, as the plates 20 and 22. Therefore the internal structure 40 may be effective in providing many heat transmission paths for transmitting heat into the interior space 14, and from there into the phase-change material 70.

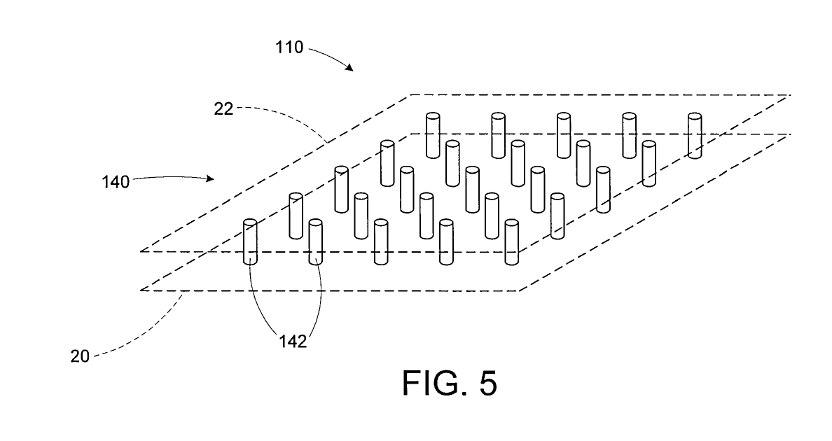

FIG. 5 shows an alternative configuration, with a structural material 110 that includes an internal structure 140 between the front plate 20 and the aft plate 22. The structure 140 includes a number of pillars 142 that extend from the front plate 20 to the aft plate 22, and which are substantially parallel to the plates 20 and 22. The remaining parts and features of the structural material 110 may be the same as or similar to those of the structural material 10 (FIG. 1). The pillars 142 provide structural support primarily in the direction parallel to their extent.

The structural materials 10 and 110 provide several advantages relative to solid-block heat-absorbing devices. The structural materials 10 and 110 are able to absorb more heat energy per unit mass, due to one or both of a) the phase-change material 70 weighing less than a comparable volume of single-phase heat absorbing material (such as a metal or alloy), and b) the phase-change being better at absorbing heat, since its absorbing involves energy being expended to change the phase of the phase-change material 70 (energy equal to the heat of fusion of the phase-change material 70). Thus the structural materials 10 and 110 may weigh less and/or have a smaller volume than comparable solid-block heat-absorbing devices. Yet there may be little if any reduction in structural performance relative to solid-block devices, due to the structural support provided by the internal structure 40. Further, the structural materials 10 and 110 may have a smaller increase in temperature than solid-block heat-absorbing devices, since some of the input energy goes to the heat of fusion, rather than to temperature increase.

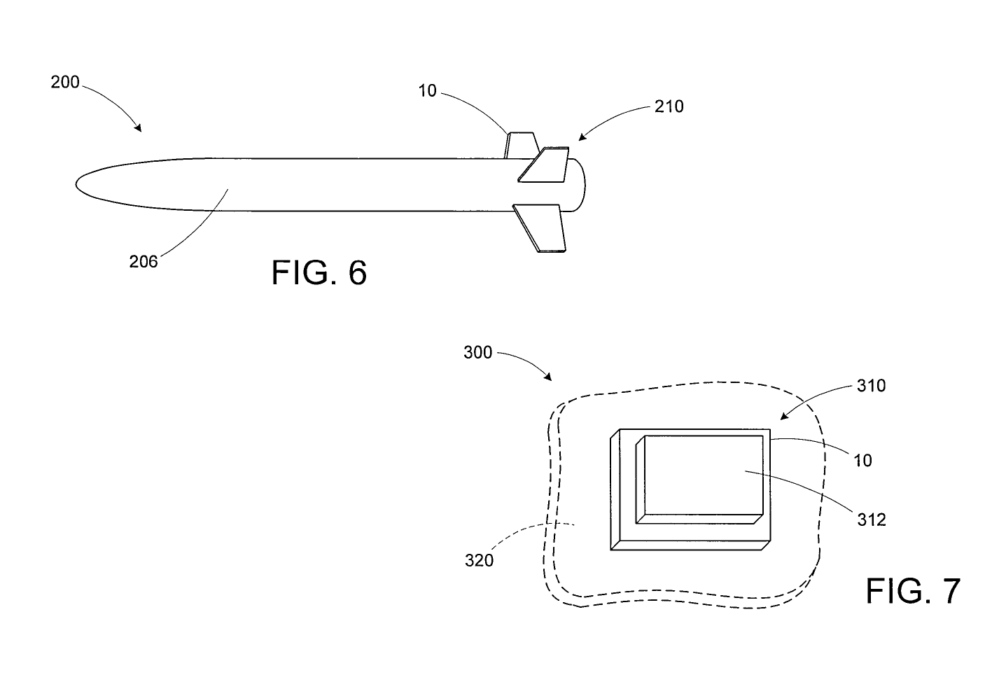

Structural materials such as the materials 10 and 110 may be used in a wide variety of devices and applications. FIG. 6 shows one possible application, with the structural material 10 used as all or part of a fin or control surface 210 extending from a fuselage 206 of a missile or other aircraft 200. The structural material 10 is used to absorb heat that is created as the aircraft 200 flies through air. The fin or control surface 210 may be fixed or movable surface. The fin or control surface 210 may be a fin that is used to provide only stability to the aircraft. Alternatively the fin or control surface 210 may be a fixed or movable surface used to provide aerodynamic force on the aircraft 200, such as for spinning a missile or steering a missile or other aircraft.

FIG. 7 shows another potential application for the heat-absorbing structural material 10 (or the structural material 110), as a heat sink 310 for electronics or other heat-producing devices 312, as part of an electronic or electrical device 300, such as a laptop computer (or other computer) or cell phone or battery. The structural material 10 may be used as at least part of a device casing 320 that provides the main structure of the device 300. It will be appreciated that the light weight and good heat absorptive capability of the structural material 10 makes it effective for use as the heat sink 310, and possibly for use as part of the device casing 320.

It will be appreciated that many other uses are possible for the heat-absorbing structural materials described above. The light weight and high heat capacity of the heat-absorbing structural materials described herein make them suitable for use wherever weight or space are a concern, particularly where a material may perform the dual functions absorbing heat and providing at least part of a load-receiving structure of an object.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A heat-absorbing structural material comprising:
a sealed container;
an inner structure within the container for providing structural support to the container; and
a phase-change material within the sealed container and interspersed around the inner structure.

2. The heat-absorbing structural material of claim 1, wherein the inner structure is a three-dimensional printed structure.

3. The heat-absorbing structural material of claim 2, wherein the inner structure is integrally formed with at least one of a pair of plates of the container, with the plates facing each other, and with the inner structure extending from one of the plates to the other of the plates.

4. The heat-absorbing structural material of claim 3, wherein the structure is also integrally formed with one or more sides of the container.

5. The heat-absorbing structural material of claim 1, wherein the inner structure and at least part of the container are both made of the same material.

6. The heat-absorbing structural material of claim 1, wherein the inner structure is a metallic inner structure.

7. The heat-absorbing structural material of claim 6, wherein the container is a metallic container.

8. The heat-absorbing structural material of claim 1, wherein the inner structure is a lattice structure.

9. The heat-absorbing structural material of claim 1, wherein the inner structure has overlapping members that extend diagonally between a front plate of the container and a back plate of the container.

10. The heat-absorbing structural material of claim 1, wherein the phase-change material is configured such that at least part of the phase-change material melts as the heat-absorbing structural material absorbs heat energy.

11. The heat-absorbing structural material of claim 1, wherein the phase-change material is a polymer material.

12. The heat-absorbing structural material of claim 1, wherein the inner structure and at least part of the sealed container around the inner structure are parts of a single continuous monolithic piece.

13. The heat-absorbing structural material of claim 1, wherein the heat-absorbing structural material forms at least part of a fin or control surface of an aircraft.

14. The heat-absorbing structural material of claim 1,
in combination with a heat-producing device;
wherein the heat-absorbing structure is in contact with the heat-producing device, and functions as a heat sink.

15. The combination of claim 14, wherein the heat-absorbing structural material is at least part of a casing that encloses the heat-producing device.

16. A method of absorbing heat, the method comprising:
receiving the heat on a face of a sealed container of a heat-absorbing structural material;
transferring the heat from the sealed container to a phase-change material that is in an interior space within the container and defined by the container;
wherein the transferring the heat includes melting at least some of the phase-change material.

17. The method of claim 16,
wherein the face is on a metallic plate of the container; and
wherein the transferring includes transferring the heat through a metallic inner structure that is in the interior space, and that the phase-change material is interspersed around.

18. The method of claim 17, wherein the metallic plate and the metallic structure are both parts of a single continuous monolithic piece.

19. The method of claim 16, wherein the phase-change material includes a polymer material.
